(19) United States
(12) Patent Application Publication
(10) Pub. No.: US 2010/0068945 A1
(43) Pub. Date: Mar. 18, 2010

(54) Modularized connector for computer

(76) Inventor: Chun-Chi Chou, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,327

(22) Filed: Sep. 16, 2008

(51) Int. Cl. H01R 13/514

(52) U.S. Cl. 439/701

(57) ABSTRACT

The present invention provides a modularized connector for a computer, including a housing forming at least three receptacle chambers and having an end face forming a notch and an opposite end face forming wire retention sections respectively communicating the receptacle chambers, and also forming mounting sections close to the wire retention sections; a first connector received in one of the receptacle chambers and having conductive connection wires extending through the respective wire retention section, the first connector being encased by a metal casing; second connectors respectively received in the remaining ones of the receptacle chambers and each having conductive connection wires extending through the respective wire retention section, each second connector being encased by a metal casing that has an end wall forming at least one resilient tab; and a conductor block arranged in the notch and having opposite side faces in physical engagement with the metal casings of the first and second connectors that juxtapose each other. The modularized connector features easy mounting/dismounting and enhanced EMI performance.

### FIELD OF THE INVENTION

The present invention relates to a modularized connector for a computer, and in particular to a modularized connector featuring easy mounting/dismounting and enhanced EMI (electromagnetic interference) performance.

### BACKGROUND OF THE INVENTION

A computer device is often equipped with connectors for connection external devices. Such connectors can be mounted to an edge of a main board in such a way that mating surfaces or openings of the connectors are exposed through a wall of the computer enclosure to allow plugging of the external devices to the connectors on the wall of the computer enclosure for expansion of the hardware and functionality of the computer in a convenient manner.

Although convenient connection with the external devices can be easily realized through the connectors exposed on the wall of the computer enclosure, yet the connectors that are mounted to the main board of the computer are not allowed to easily dismount from the main board. Thus, when a connector is broken or fails to properly function, it is generally impossible for a regular computer user to replace the broken connector and the computer has to be returned to the factory for maintenance and repairing. This makes the maintenance and repairing difficult for the general consumers. Further, since the conventional connectors are often set in physical engagement with the computer enclosure, which is considered a grounding potential, with a metal censing thereof, the grounding area of the connectors is apparently very small and the impedance thereof cannot be enhanced, eventually leading to poor electromagnetic shielding and affecting electrical performance of the connectors. Thus, the conventional electrical connectors provided for computers do not suit practical needs of using computers.

### SUMMARY OF THE INVENTION

An objective of the present invention is to provide easy mounting/dismounting and enhanced EMI performance during the operation thereof.

To realize the above objective, the present invention provides a modularized connector for a computer, comprising a housing, which forms at least three receptacle chambers and has an end face forming a notch and an opposite end face forming wire retention sections respectively in communication with the receptacle chambers, and also forms mounting sections in the proximity of the wire retention sections; a first connector received in one of the receptacle chambers and having conductive connection wires extending through the respective wire retention section, the first connector being encased by a metal casing; second connectors respectively received in the remaining ones of the receptacle chambers and each having conductive connection wires extending through the respective wire retention section, each second connector being encased by a metal casing that has an end wall forming at least one resilient tab; and a conductor block arranged in the notch and having opposite side faces in physical engagement with the metal casings of the first and second connectors that juxtapose each other.

### BRIEF DESCRIPTION OF THE DRAWINGS

The present invention will be apparent to those skilled in the art by reading the following description of preferred embodiments thereof with reference to the drawings, in which:

FIG. 1 is a perspective view of a modularized connector constructed in accordance with the present invention;

FIG. 2 is a front-side exploded view of the modularized connector of the present invention;

FIG. 3 is a rear-side exploded view of the modularized connector of the present invention; and

FIG. 4 illustrates an application of the modularized connector of the present invention.

### DETAILED DESCRIPTION OF THE PREFERRED EMBODIMENT

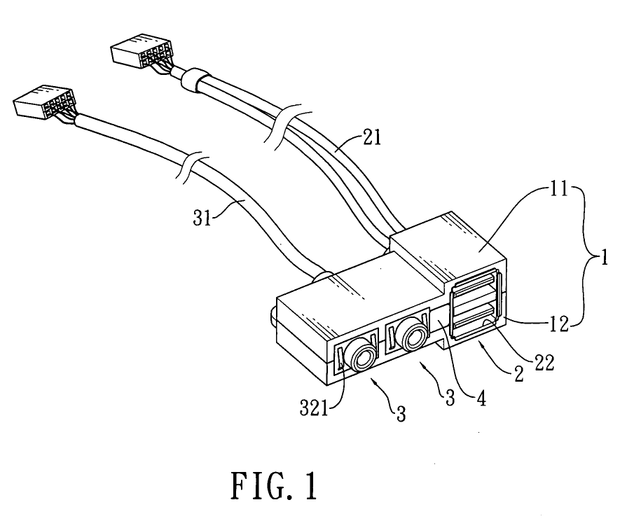

With reference to the drawings and in particular to FIGS. 1-3, which respectively show a perspective view, a front-side exploded view, and a rear-side exploded view of a modularized connector constructed in accordance with the present invention for a computer, as shown, the present invention provides a modularized connector for a computer, comprising a housing 1, a first connector 2, and at least two second connectors 3, and a conductor block 4.

The housing 1 is comprised of an upper member 11 and a lower member 12. The upper and lower members 11, 12 respectively form mated mounting poles 13 and holed projections 14. The housing 1 defines therein at bleast three receptacle chambers 15, 15a, 15b that are arranged in a juxtaposing manner and communicate an end face of the housing 1. The housing 1 has an end face forming a notch 16 communicating between at least two 15, 15a of the receptacle chambers. The housing 1 also has an opposite end face that forms wire retention sections 17, 18 defining therein passages in communication with the receptacle chambers 15, 15a, 15b. Mounting sections 19 are formed at location close to the wire retention sections 17, 18.

The first connector 2 is received in the receptacle chamber 15 and has conductive connection wires 21 extending through the wire retention section 17. The first connector 21 is encased by a metal casing 22. The first connector 2 can be a single-layer USB (Universal Serial Bus) connector or a double-layer USB connector.

The second connectors 3 are received in the receptacle chambers 15a, 15b respectively and each has conductive connection wires 31, preferably surrounded by a jacket, extending through the wire retention section 18. Each connector 3 is encased by a metal casing 32 has an end wall forming at least one resilient tab 321. The second connectors 3 can be for example an earphone signal connector and a microphone signal connector.

The conductor block 4 is received in the notch 16 of the housing 1 and has opposite side surfaces respectively and physically engaging the metal casings 22, 32 of the juxtaposing first and second connectors 22, 32. The conductor block 4 can be made of electrically conductive foaming materials. As such, with the above described construction, a novel, modularized connector is provided for a computer.

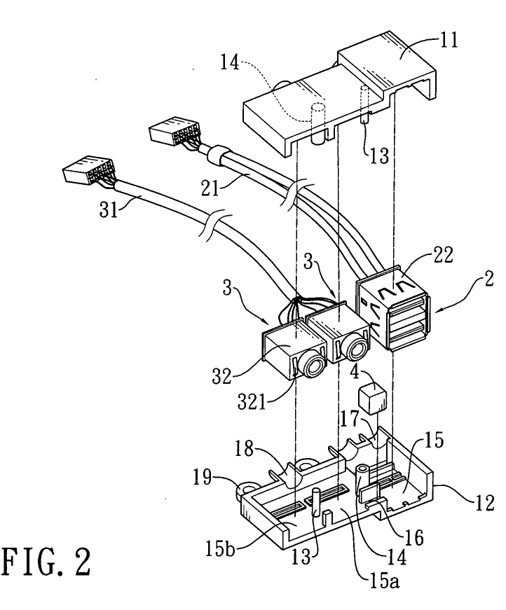

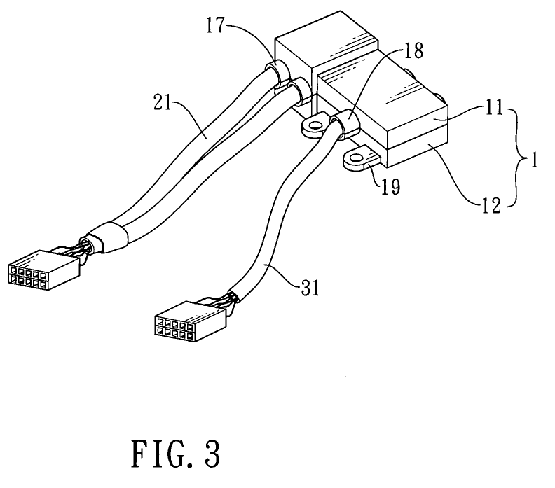

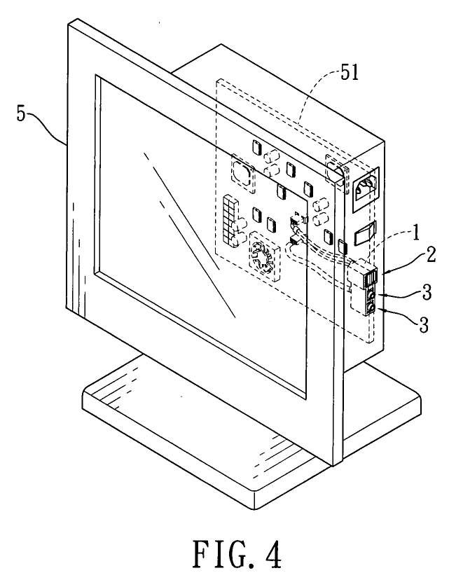

Referring to FIG. 4, which illustrates an application of the modularized connector of the present invention to a computer, as shown, in the application of the modularized connector (also referring to FIGS. 2 and 3) to a computer 5, the modularized connector of the present invention is first positioned in registration with an opening defined in one side of the computer enclosure from either inside or outside the computer, and the mounting sections 19 are secured to mating parts inside the computer 5 through fasteners (not shown). The conductive connection wires 21, 31 of the connectors 2, 3 are then set in electrical connection with a main board 51 of the computer 5. As such, the assembling of the modularized connector of the present invention to the computer is completed. On the other hand, to remove the modularized connector of the present invention from the computer, the fasteners are loosened and the conductive connection wires 21, 31 of the connectors 2, 3 that are connected to the main board 51 are released from the computer main board. Then, the modularized connector can be removed. Thus, the present invention features easy mounting/dismounting.

To use the modularized connector (see FIGS. 2 and 3) mounted to the computer, a plug connector of a peripheral device of the computer is directly inserted into the corresponding one of the first and second connectors 2, 3 to allow establishment of electrical conduction for signal transmission with the first and second connectors 2, 3. When signal transmission is in progress between the first and second connectors 2, 3 and the external peripheral device, physical engagement among the metal casing 22 of the first connector 2 and the resilient tabs 321 of the metal casing 32 of the second connectors 3, the conductor block 4, and corresponding internal parts of the computer 5 provides an increased grounding area for both first and second connectors 2, 3 and enhancement of impedance thereof, whereby enhanced EMI performance can be realized.

To conclude, the modularized connector for a computer in accordance with the present invention features easy mounting/dismounting and enhanced EMI performance in the operation thereof.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A modularized connector for a computer, comprising:
a housing, which forms at least three receptacle chambers arranged in a juxtaposing manner and communicating an end face of the housing, the housing having an end face forming a notch communicating between at least two of the receptacle chambers and an opposite end face forming wire retention sections respectively in communication with the receptacle chambers, mounting sections being formed in the proximity of the wire retention sections;
a first connector received in one of the receptacle chambers and having conductive connection wires extending through the respective wire retention section, the first connector being encased by a metal casing;
at least two second connectors respectively received in the remaining ones of the receptacle chambers and each having conductive connection wires extending through the respective wire retention section, each second connector being encased by a metal casing that has an end wall forming at least one resilient tab; and
a conductor block arranged in the notch of the housing and having opposite side faces in physical engagement with the metal casings of the first and second connectors that juxtapose each other.

2. The modularized connector as claimed in claim 1, wherein the housing comprises an upper member and a lower member, which respectively form poles and holes mating each other.

3. The modularized connector as claimed in claim 1, wherein the first connector is a universal serial bus connector.

4. The modularized connector as claimed in claim 3, wherein the universal serial bus connector comprises a single-layered universal serial bus connector.

5. The modularized connector as claimed in claim 3, wherein the universal serial bus connector comprises a double-layered universal serial bus connector.

6. The modularized connector as claimed in claim 1, wherein the second connectors are an earphone signal connector and a microphone signal connector.

7. The modularized connector as claimed in claim 1, wherein the conductor block is made of electrically conductive foaming materials.
